(19) United States
(12) Patent Application Publication
(10) Pub. No.: US 2012/0062870 A1
(43) Pub. Date: Mar. 15, 2012

(54) PHYSICAL STATE MEASURING APPARATUS AND PHYSICAL STATE MEASURING METHOD

(75) Inventors: Jun YAMAWAKU, Nirasaki City (JP); Chishio KOSHIMIZU, Nirasaki City (JP); Tatsuo MATSUDO, Nirasaki City (JP); Kenji NAGAI, Nirasaki City (JP)

(73) Assignee: TOKYO ELECTRON LIMITED, Tokyo (JP)

(21) Appl. No.: 13/231,037

(22) Filed: Sep. 13, 2011

Related U.S. Application Data
(60) Provisional application No. 61/386,132, filed on Sep. 24, 2010.

(30) Foreign Application Priority Data
Sep. 14, 2010 (JP) 2010-205402

(51) Int. Cl. G01B 9/02

(52) U.S. Cl. 356/51; 356/450

(57) ABSTRACT

The physical state measuring apparatus includes: a light source; a transmitting unit which transmits a light from the light source to a measurement point of an object to be measured; a nonlinear optical device which changes a wavelength of the light reflected by the measurement point to a wavelength that is different from the wavelength before the changing; a light receiving unit which receives the light whose wavelength has been changed; and a measuring unit which measures a physical state of the object to be measured at the measurement point based on a waveform of the light received by the light receiving unit.

### CROSS-REFERENCE TO RELATED PATENT APPLICATIONS

This application claims the benefit of Japanese Patent Application No. 2010-205402, filed on Sep. 14, 2010, in the Japan Patent Office, and U.S. Patent Application No. 61/386,132, filed on Sep. 24, 2010, in the United States Patent and Trademark Office, the disclosures of which are incorporated herein in their entireties by reference.

### BACKGROUND OF THE INVENTION

1. Field of the Invention

The present invention relates to a physical state measuring apparatus and a physical state measuring method which can measure a physical state of an object to be measured in a non-contact manner.

2. Description of the Related Art

Accurately measuring a physical state (for example, an internal structure or a temperature) of a substrate (for example, a semiconductor wafer) to be processed by using a substrate processing apparatus is very important in order to accurately control shapes, properties, and so on of films or holes formed on or in the semiconductor wafer based on a result of various processes such as film formation and etching. Accordingly, an internal structure or a temperature of a semiconductor wafer has been measured by using various conventional methods such as a focused ion beam-scanning electron microscope (FIB-SEM) and a fluorescent thermometer.

Recently, a measuring technology using a low-coherence interferometer which can directly measure an internal structure or a temperature of a semiconductor wafer which is difficult to do with the conventional temperature measuring methods has been developed. Also, as the measuring technology using the low-coherence interferometer, a technology has been suggested in which a light from a light source is divided into a measurement light for temperature measurement and a reference light by a first splitter, the measurement light is divided into n measurement lights by a second splitter, the n measurement lights are emitted to n measurement points, and interference between reflected lights of the n measurement lights and a reflected light of the reference light reflected by a reference light reflecting unit is measured to simultaneously measure temperatures of the plurality of measurement points (refer to, for example, Patent Document 1).

In a conventional technology which emits a light from a light source to an object to be measured and measures a physical state of the object to be measured by using a reflected light as described above, it is necessary to select a wavelength of the light emitted from the light source according to the object to be measured and the physical state to be measured. For example, in the conventional technology, in order to measure a temperature of a semiconductor wafer, it is necessary to use a light having a wavelength (for example, a wavelength equal to or greater than 1000 nm) which passes through silicon (Si) of which the semiconductor wafer is formed. Accordingly, it is necessary to use a light receiving element (for example, an InGaAs photodiode) having a sensitivity to a light having a wavelength equal to or greater than 1000 nm as a light receiving unit. However, since the InGaAs photodiode has a lower responsiveness than a Si photodiode, the physical state of the object to be measured cannot be measured at a high speed.
[Patent Document 1] Japanese Laid-Open Patent Publication No. 2006-112826

### SUMMARY OF THE INVENTION

Considering the problems of the conventional technology, an objective of the present invention is to provide a physical state measuring apparatus and a physical state measuring method which can measure a physical state of an object to be measured at a speed higher than that of a conventional apparatus and method even when a light having a long wavelength equal to or greater than 1000 nm should be used.

According to an aspect of the present invention, there is provided a physical state measuring apparatus including: a light source; a transmitting unit which transmits a light from the light source to a measurement point of an object to be measured; a nonlinear optical device which changes a wavelength of the light reflected by the measurement point to a wavelength that is different from the wavelength of the light before the changing; a light receiving unit which receives the light whose wavelength has been changed; and a measuring unit which measures a physical state of the object to be measured at the measurement point based on a waveform of the light received by the light receiving unit.

According to another aspect of the present invention, there is provided a physical state measuring method including: transmitting a light from a light source to a measurement point of an object to be measured; changing a wavelength of the light reflected by the measurement point to a wavelength that is different from the wavelength of the light before the changing; receiving the light whose wavelength has been changed; and measuring a physical state of the object to be measured at the measurement point based on a waveform of the received light.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram showing a configuration of a physical state measuring apparatus according to a first embodiment;

FIG. 2 is a diagram showing a function of a temperature calculating unit;

FIGS. 3A and 3B are graphs specifically showing an interference waveform;

FIG. 4 is a diagram showing a configuration of a physical state measuring apparatus according to a second embodiment;

FIG. 5 is a diagram showing a configuration of a light receiving unit;

FIG. 6 is a diagram showing a function of a temperature calculating unit;

FIG. 7 is a graph showing a signal after discrete Fourier transformation (DFT);

FIG. 8 is a graph showing a relationship between an optical path length and a temperature, which is stored in a memory unit;

FIG. 9 is a diagram showing a configuration of a physical state measuring apparatus according to a third embodiment;

FIGS. 10A and 10B are diagrams for explaining a method of selecting a wavelength; and

FIG. 11 is a diagram showing a configuration of a physical state measuring apparatus according to a fourth embodiment.

### DETAILED DESCRIPTION OF THE INVENTION

### Embodiments for Carrying Out the Invention

The present invention will now be described more fully with reference to the accompanying drawings, in which exemplary embodiments of the invention are shown. Also, in the specification and drawings, components having substantially the same functions are denoted by the same reference numerals, and a repeated explanation thereof will not be given. Also, although a semiconductor wafer is exemplarily explained as an object to be measured and a temperature of the semiconductor wafer is exemplarily explained as a physical state, the object to be measured is not limited to the semiconductor wafer and various other objects may be measured. Also, the physical state is not limited to the temperature and various other physical states (for example, an internal structure) may be measured.

### First Embodiment

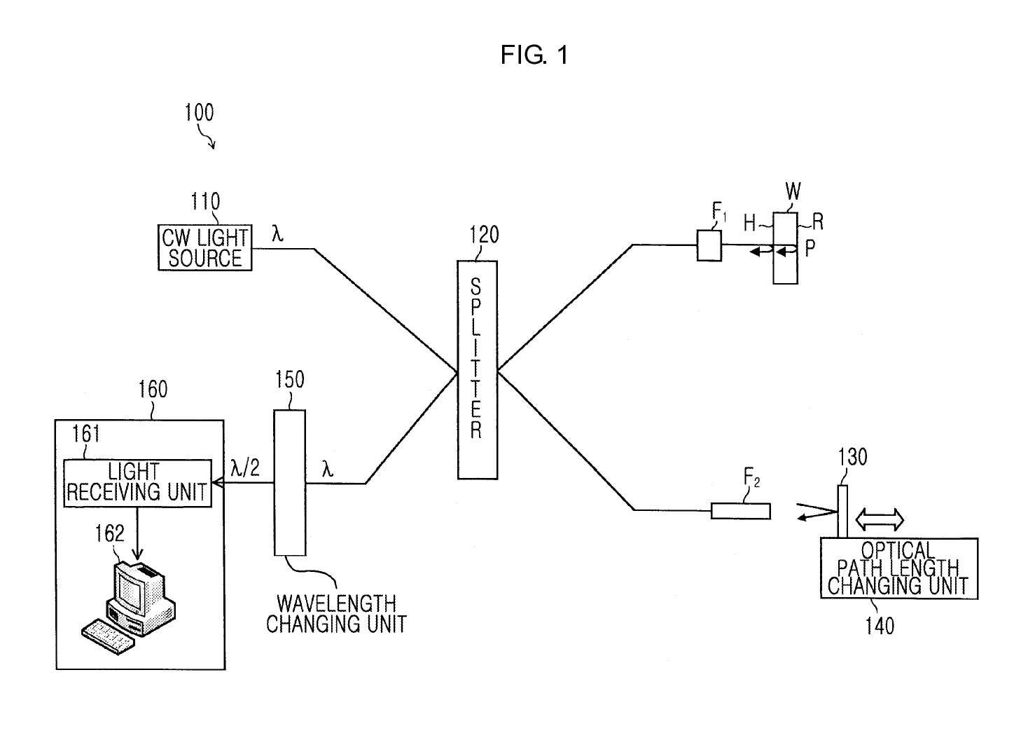

FIG. 1 is a diagram showing a configuration of a physical state measuring apparatus 100 according to a first embodiment. The physical state measuring apparatus 100 according to the first embodiment includes a continuous wave (CW) light source 110, a splitter 120 which divides a light from the CW light source 110 into a light for temperature measurement (referred to as a measurement light) and a reference light, a collimator fiber F₁ which transmits the measurement light to a measurement point P of an object to be measured W (for example, a semiconductor wafer), a reference light reflecting unit 130 which reflects the reference light from the splitter 120, a collimator fiber F₂ which transmits the reference light obtained by the splitter 120 to the reference light reflecting unit 130, an optical path length changing unit 140 which changes an optical path length of the reference light reflected from the reference light reflecting unit 130, a wavelength changing unit 150 which changes wavelengths of reflected lights from the reference light reflecting unit 130 and the measurement point P of the object to be measured W, and a signal processing apparatus 160 which measures a temperature of the measurement point P of the object to be measured W based on an interference waveform caused by the reflected lights of the measurement light and the reference light whose wavelengths are changed by the wavelength changing unit 150. The signal processing apparatus 160 includes a light receiving unit 161 and a temperature calculating unit 162.

The CW light source 110 is a light source which generates a continuous light. Although the CW light source 110 can use an arbitrary light as long as interference between a measurement light and a reference light can be measured, since a temperature of a semiconductor wafer is measured as a temperature of the object to be measured W in the first embodiment, a light whose reflected light from a distance (it is generally in a range of 800 to 1500 μm) between a surface H and a rear surface R of the semiconductor wafer which is the object to be measured W does not cause interference may be used.

Specifically, a low-coherence light may be used. A low-coherence light refers to a light having a short coherence length. A center wavelength of a low-coherence light may be equal to or greater than 1000 nm so that a low-coherence light can pass through silicon (Si) which is a main component of the semiconductor wafer which is the object to be measured W. Also, a coherence length may be, for example, in a range of 0.1 to 100 μm, and a coherence length may be equal to or less than 3 μm. Since the CW light source 110 uses such a low-coherence light, obstruction due to unnecessary interference can be avoided, and interference with a reference light based on a reflected light from an inner layer or the surface of the wafer can be easily measured.

The splitter 120 is, for example, an optical fiber coupler. However, the present embodiment is not limited thereto, and for example, an optical waveguide type branching filter or a semi-transmissive mirror, may be used as the splitter 120 as long as it can split a light to a reference light and a measurement light.

Examples of the reference light reflecting unit 130 may include a corner cube prism and a plane mirror. From among the corner cube prism and the plane mirror, considering that a reflected light is parallel to an incident light, a corner cube prism may be used. However, the present embodiment is not limited thereto, and the reference light reflecting unit 130 may include, for example, a delay line as long as the delay line can reflect a reference light.

The optical path length changing unit 140 includes a driving unit such as a motor for driving the reference light reflecting unit 130 which includes, for example, a reference mirror, in one direction parallel to an incident direction in which a reference light is incident. As such, an optical path length of a reference light reflected from the reference mirror can be changed by driving the reference mirror in one direction.

The wavelength changing unit 150 changes wavelengths of the measurement light reflected by the measurement point P of the object to be measured W and the reference light reflected by the reference light reflecting unit 130 to wavelengths (specifically, wavelengths less than 1000 nm) which can be received by the light receiving unit 161.

The wavelength changing unit 150 may be, for example, a nonlinear optical crystal which radiates a second-harmonic wave having a half (λ/2) of a wavelength λ of an input light. Since the nonlinear optical crystal is used, a wavelength of a light can be changed while a phase of the light is maintained. Examples of the nonlinear optical crystal may include a lithium niobate (LiNbO₃) crystal, a potassium titanyl phosphate (KTP) crystal, a β-barium borate (BBO) crystal, a lithium triborate (LBO) crystal, a AgGaS₂ crystal, a AgGaSe₂ crystal, and a periodically poled lithium niobate (PPLN) crystal.

The light receiving unit 161 converts the reflected lights of the measurement light and the reference light whose wavelengths are changed by the wavelength changing unit 150 to electrical signals. In the first embodiment, the light receiving unit 161 includes a charged-coupled device (CCD) image sensor using a Si photodiode.

As described above, since an InGaAs photodiode having a sensitivity to a light having a wavelength equal to or greater than 1000 nm has a responsiveness lower than that of a Si photodiode, a temperature of the object to be measured W cannot be measured at a high speed. Accordingly, in the first embodiment, a temperature is measured at a high speed by changing a wavelength to a wavelength which can be received by the light receiving unit 161 including the CCD image sensor using the Si photodiode by using the wavelength changing unit 150. Also, since the CCD image sensor using the Si photodiode can form a photodiode at high density, a resolution, that is, a number of samples can be improved. Also, likewise, a resolution can be improved even by using a complementary metal-oxide-semiconductor (CMOS) image sensor instead of the CCD image sensor. Also, a sampling speed can be increased, a compact design can be achieved, and power consumption can be reduced.

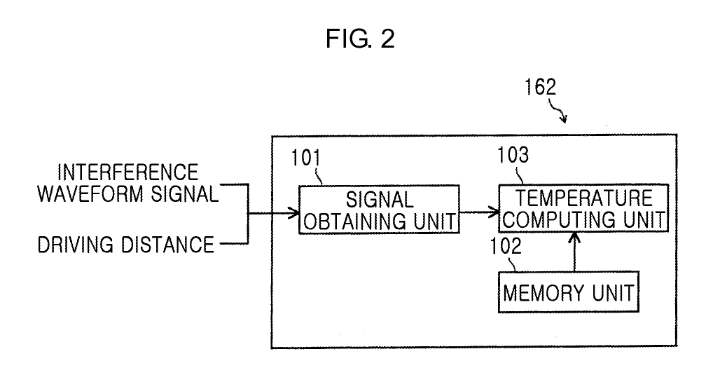

FIG. 2 is a diagram showing a function of the temperature calculating unit 162. The temperature calculating unit 162 is, for example, a computer, and calculates a temperature of the object to be measured W based on an interference waveform detected by the light receiving unit 161. The temperature calculating unit 162 includes a signal obtaining unit 101, a memory unit 102, and a temperature computing unit 103. Also, the function shown in FIG. 2 is performed by using hardware (for example, a hard disk drive (HDD), a central processing unit (CPU), and a memory) included in the temperature calculating unit 162. In detail, the function is performed when the CPU executes a program recorded on the HDD or the memory.

The signal obtaining unit 101 obtains a waveform signal from the light receiving unit 161 and a driving distance signal of the reference light reflecting unit 130 from the optical path length changing unit 140.

The memory unit 102 is, for example, a nonvolatile memory such as a flash memory or a ferroelectric random-access memory (FeRAM). Properties and equations for calculating a temperature of the measurement point P are stored in the memory unit 102. In detail, a linear expansion coefficient α and a temperature coefficient β refractive index change according to a temperature of the object to be measured W, and equations that will be explained below are stored.

The temperature computing unit 103 calculates a temperature of the measurement point P of the object to be measured W based on the waveform signal from the light receiving unit 161 and the driving distance signal of the reference light reflecting unit 130 from the optical path length changing unit 140 by referring to the memory unit 102. A detailed calculating method will be explained in (Temperature Measuring Method Based on Interference Light) that will be explained below.

(Operation of Physical State Measuring Apparatus)

As shown in FIG. 1, in the physical state measuring apparatus 100, a light from the CW light source 110 is incident on the splitter 120, and is divided into two lights by the splitter 120. From among the two lights, one light (measurement light) is emitted to the object to be measured W through the collimator fiber F₁, and is reflected by an inner layer or a structure and the surface H or the rear surface R.

The other light (reference light) obtained by the splitter 120 is emitted from the collimator fiber F₂ and is reflected by the reference light reflecting unit 130. Then, a reflected light of the reference light is incident on the splitter 120, is combined with a reflected light of the measurement light, and is wavelength-changed by the wavelength changing unit 150. An interference waveform is detected by the signal processing apparatus 160, and a temperature of the measurement point P is calculated based on the interference waveform.

(Specific Example of Interference Waveform Between Measurement Light and Reference Light)

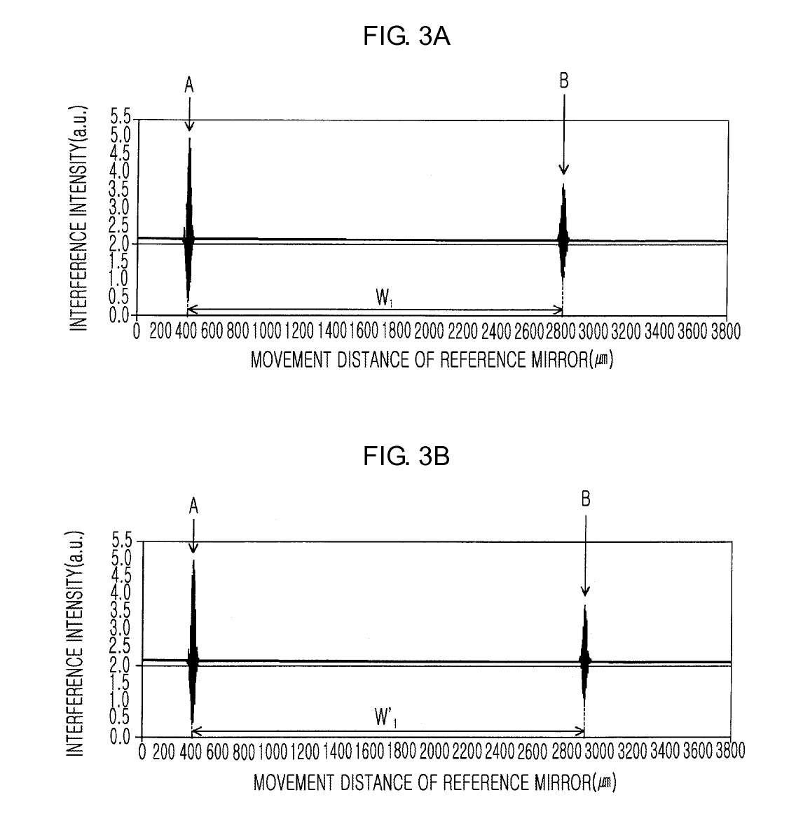

Here, a specific example of an interference waveform obtained by the physical state measuring apparatus 100 is shown in FIGS. 3A and 3B. FIGS. 3A and 3B show an interference waveform between a measurement light and a reference light when the measurement light is emitted to the measurement point P within a surface of the object to be measured W. FIG. 3A shows an interference waveform before a temperature change, and FIG. 3B shows an interference waveform after the temperature change. In FIGS. 3A and 3B, a vertical axis represents an interference intensity and a horizontal axis represents a movement distance of a reference mirror.

Referring to FIGS. 3A and 3B, when the reference light reflecting unit (for example, the reference mirror) 130 is scanned in one direction, an interference wave A between the surface H of the measurement point P of the object to be measured W and the reference light occurs, and then, an interference wave B between the rear surface R of the measurement point P of the object to be measured W and the reference light occurs.

(Temperature Measuring Method Based on Interference Light)

Next, a method of measuring a temperature based on an interference wave between a measurement light and a reference light will be explained. A temperature measuring method based on an interference wave is, for example, a temperature converting method which uses an optical path length change based on a temperature change. Here, a temperature converting method using a misalignment of the interference waveform will be explained.

Since, when the object to be measured W is heated due to a heater or the like, the object to be measured W is expanded and a refractive index of the object to be measured W is changed, there is a misalignment of an interference waveform between before a temperature change and after the temperature change, and thus a width between peaks of the interference waveform is changed. The temperature change can be detected by measuring the width between the peaks of the interference waveform of the measurement point. For example, in the physical state measuring apparatus 100 shown in FIG. 1, since a width between peaks of an interference waveform corresponds to a movement distance of the reference light reflecting unit 130, a temperature change can be detected by measuring the movement distance of the reference light reflecting unit 130 corresponding to the width between the peaks of the interference waveform.

If a thickness and a refractive index of an object whose temperature is to be measured are respectively d and n, a misalignment of an interference waveform is dependent on a unique linear expansion coefficient α of each layer for the thickness d, and is dependent mainly on a unique temperature coefficient β of refractive index change of each layer for the change of the refractive index n. It is known that the misalignment of the interference waveform is also dependent on a wavelength for the temperature coefficient β of refractive index change.

Accordingly, a thickness d′ and a refractive index n′ of a wafer after a temperature change at a certain measurement point P may be defined as shown in Equation 1. Also, in Equation 1, ΔT denotes an amount of temperature change of the measurement point, α denotes a linear expansion coefficient, and β denotes a temperature coefficient of refractive index change. Also, d and n respectively denote a thickness and a refractive index at the measurement point P before the temperature change.

[Equation 1]

d′=d·(1+αΔT), n′=n·(1+βΔT) (1)

As shown in Equation 1, an optical path length of a measurement light which passes through the measurement point P varies according to the temperature change. An optical path length is generally obtained by multiplying the thickness d by the refractive index n. Accordingly, if an optical path length of a measurement light which passes through the measurement point P before a temperature change is L and an optical path length after a temperature of the measurement point P is changed by ΔT is L′, the optical path lengths L and L′ are defined as shown in Equation 2.

[Equation 2]

L=d·n, L′=d′·n′ (2)

Accordingly, a difference (L′−L) between the optical path length L before the temperature change and the optical path length L′ after the temperature change at the measurement point is defined as shown in Equation 3 by referring to Equations 1 and 2. Also, in Equation 3, small terms are omitted in consideration of α·β [symbol] α, α·β [symbol] β.

$$\begin{matrix}[ Equation 3 ] & \\ \begin{matrix}{L}^{′} - L = {d}^{′} \cdot {n}^{′} - d \cdot n \\ = d \cdot n \cdot ( α + β ) \cdot Δ T \\ = L \cdot ( α + β ) \cdot Δ T\end{matrix} & ( 3 )\end{matrix}$$

Here, an optical path length of a measurement light at a measurement point corresponds to a width between peaks of an interference waveform with a reference light. Accordingly, if a linear expansion coefficient α and a temperature coefficient β of refractive index change are obtained in advance, a width between peaks of an interference waveform with a reference light at a measurement point is measured to be converted to a temperature of the measurement point by using Equation 3.

As such, if an interference wave is converted to a temperature, since an optical path length between peaks of an interference waveform varies according to a linear expansion coefficient α and a temperature coefficient β of refractive index change as described above, the linear expansion coefficient α and a temperature coefficient β of refractive index change need to be obtained in advance. A linear expansion coefficient α and a temperature coefficient β of refractive index change of a material including a semiconductor wafer may be generally dependent on a temperature in a certain temperature range. For example, in general, since a linear expansion coefficient α is not much changed when a temperature ranges from 0 to 100° C., the linear expansion coefficient α may be regarded as constant. However, according to materials, since a linear expansion coefficient α increases as a temperature increases when a temperature is equal to or higher than 100° C., a temperature dependency of the linear expansion coefficient α cannot be disregarded in this case. Likewise, there are cases where a temperature dependency of a temperature coefficient β of refractive index change cannot be disregarded in a certain temperature range.

For example, it is known that a linear expansion coefficient α and a temperature coefficient β of refractive index change of Si constituting a semiconductor wafer approximate to, for example, a quadratic curve in a temperature range of 0 to 500° C. As such, since a linear expansion coefficient α and a temperature coefficient β of refractive index change are dependent on temperature, a temperature can be more accurately calculated by obtaining a linear expansion coefficient α and a temperature coefficient β of refractive index change according to temperature in advance and obtaining a temperature in consideration of the obtained linear expansion coefficient α and temperature coefficient β of refractive index change.

Also, a temperature measuring method based on an interference wave between a measurement light and a reference light is not limited to the above-described method, and for example, a method using an absorbance intensity change based on a temperature change may be used or a method which combines an optical path length change based on a temperature change and an absorbance intensity change based on a temperature change may be used.

As described above, since the physical state measuring apparatus 100 includes the wavelength changing unit 150 which changes wavelengths (equal to or greater than 1000 nm) of a measurement light reflected by the measurement point P of the object to be measured W and a reference light reflected by the reference light reflecting unit 130 to wavelengths which can be received by the light receiving unit 161 including the CCD image sensor using the Si photodiode, the physical state measuring apparatus 100 can measure a temperature at a higher speed. Also, since the CCD image sensor using the Si photodiode ensures high density, a resolution, that is, a number of samples can be improved. Also, the same effect can be achieved even when a CMOS image sensor instead of the CCD image sensor is used.

### Second Embodiment

In the first embodiment, a temperature of a measurement point of the object to be measured W (for example, a semiconductor wafer) is measured by dividing a light generated by the CW light source 110 to a measurement light and a reference light, and causing the measurement light reflected by the measurement point P of the object to be measured W and the reference light reflected by the reference light reflecting unit 130 to interfere with each other. A second embodiment in which a reference light is not used will be explained.

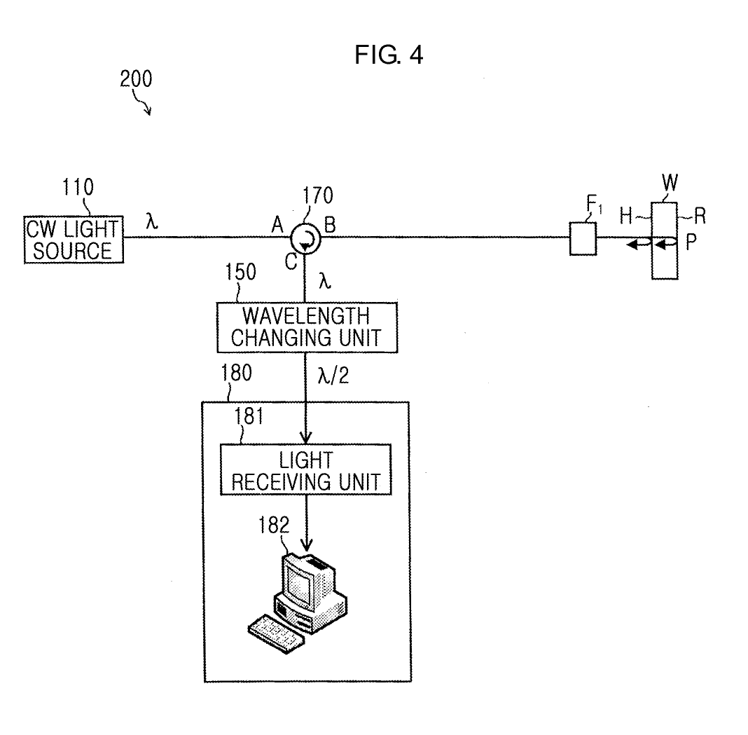

FIG. 4 is a diagram showing a configuration of a physical state measuring apparatus 200 according to the second embodiment. The physical state measuring apparatus 200 includes the CW light source 110, an optical circulator 170, the collimator fiber F₁, the wavelength changing unit 150, and a signal processing apparatus 180. The signal processing apparatus 180 includes a light receiving unit 181 and a temperature calculating unit 182. When the configuration of the physical state measuring apparatus 200 according to the second embodiment is explained below, the same components as those of the physical state measuring apparatus 100 according to the first embodiment are denoted by the same reference numerals and a repeated explanation thereof will not be given.

The optical circulator 170 includes three ports A through C. A light input to the port A is output from the port B, a light input to the port B is output from the port C, and a light input to the port C is output from the port A. That is, a measurement light input from the CW light source 110 is emitted to the object to be measured W through the collimator fiber F₁, and a reflected light from the object to be measured W is input to the light receiving unit 181 of the signal processing apparatus 180.

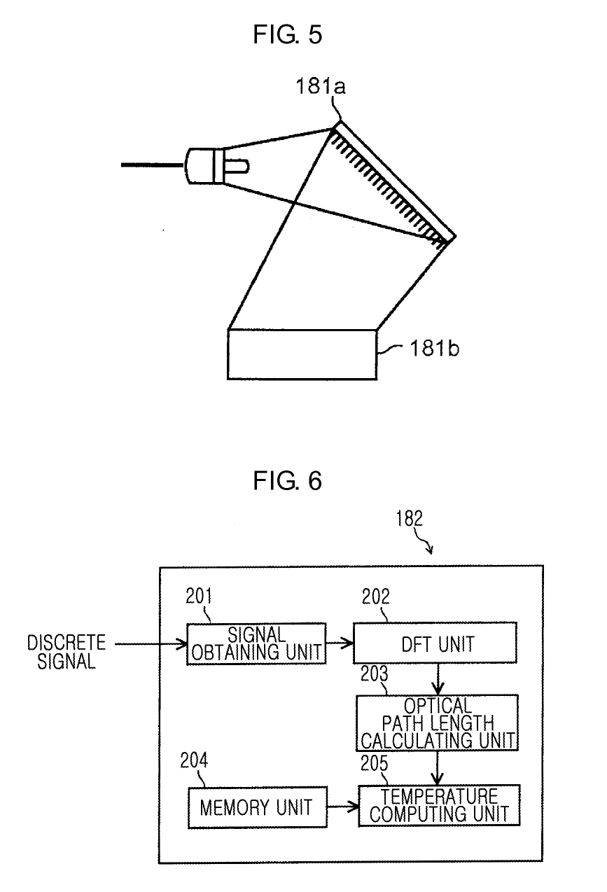

FIG. 5 is a diagram showing a configuration of the light receiving unit 181. The light receiving unit 181 includes a diffraction grating 181a which wavelength-resolves a reflected light from the optical circulator 170, and a CCD image sensor 181b using a Si photodiode which converts the wavelength-resolved reflected light to an electrical signal.

FIG. 6 is a diagram showing a function of the temperature calculating unit 182. The temperature calculating unit 182 is, for example, a computer, and calculates a temperature of the object to be measured W based on a discrete signal input from the light receiving unit 181. The temperature calculating unit 182 includes a signal obtaining unit 201, a discrete Fourier transformation (DFT) unit 202, an optical path length calculating unit 203, a memory unit 204, and a temperature computing unit 205. Also, the function shown in FIG. 6 is performed by hardware (for example, an HDD, a CPU, and a memory) included in the temperature calculating unit 182. In detail, the function is performed when the CPU executes a program recorded on the HDD or the memory.

The signal receiving unit 201 obtains a discrete signal from the light receiving unit 181.

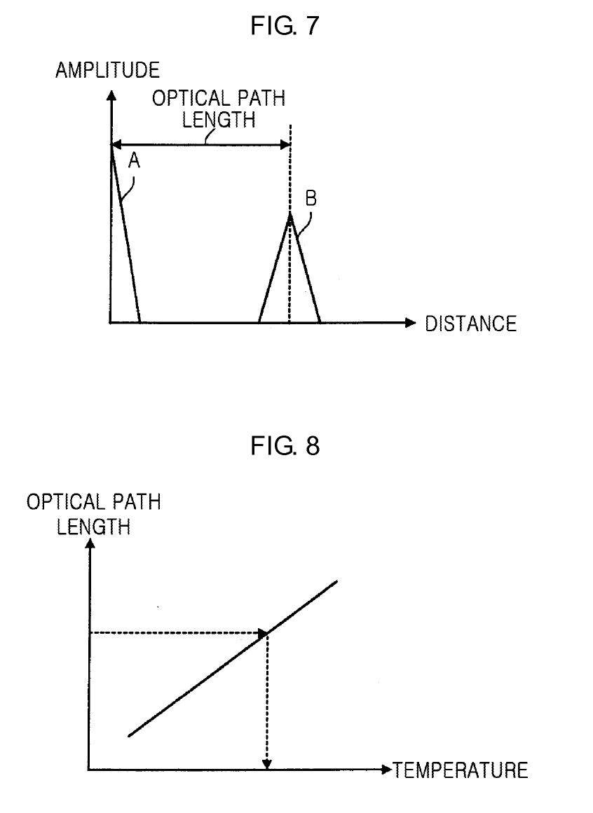

The DFT unit 202 performs DFT on the discrete signal obtained by the signal obtaining unit 201. Due to the DFT, the discrete signal from the light receiving unit 181 is converted to information regarding an amplitude and a distance. FIG. 7 is a graph showing a signal after DFT. A vertical axis of FIG. 7 represents an amplitude and a horizontal axis of FIG. 7 represents a distance.

The optical path length calculating unit 203 calculates an optical path length based on the information regarding the amplitude and the distance obtained by the DFT unit 202. In detail, a distance between a peak A and a peak B shown in FIG. 7 is calculated. The peak A and the peak B shown in FIG. 7 are caused by interference between a reflected light from the surface H and a reflected light from the rear surface R of the object to be measured W, and a difference in the optical path length is dependent on a temperature of the object to be measured W. This is because when a temperature of the object to be measured W is changed, an optical path length between the surface H and the rear surface R of the object to be measured W is changed due to a change in the thermal expansion and refractive index of the object to be measured W.

A relationship between an optical path length and a temperature shown in FIG. 8 is stored in the memory unit 204. An optical path length between the peak A and the peak B shown in FIG. 7 is dependent on a temperature of the object to be measured W as described above. Accordingly, if a relationship between an optical path length between the peak A and the peak B and a temperature of the object to be measured W is stored in the memory unit 204 in advance, a temperature of the object to be measured W can be calculated from the optical path length calculated by the optical path length calculating unit 203.

Also, a relationship between an optical path length and a temperature shown in FIG. 8 may be measured through actual experiments and the like and stored in the memory unit 204, or may be calculated from a property of a semiconductor wafer formed of Si and stored in the memory unit 204. The memory unit 204 is, for example, a nonvolatile memory such as a flash memory or a FeRAM.

The temperature computing unit 205 calculates a temperature of the object to be measured W from the optical path length calculated by the optical path length calculating unit 203 by referring to the memory unit 204.

As described above, since the physical state measuring apparatus 200 according to the second embodiment calculates an optical path length by converting a reflected light from the measurement point P to a discrete signal by using the light receiving unit 181 and performing DFT on the discrete signal, and since a reference mirror does not need to be mechanically operated unlike a case where an optical path length is calculated by using interference with a reflected light from a reference mirror, a temperature of the measurement point can be very rapidly measured and thus can be efficiently measured. Other effects are the same as those of the physical state measuring apparatus 100 according to the first embodiment.

### Third Embodiment

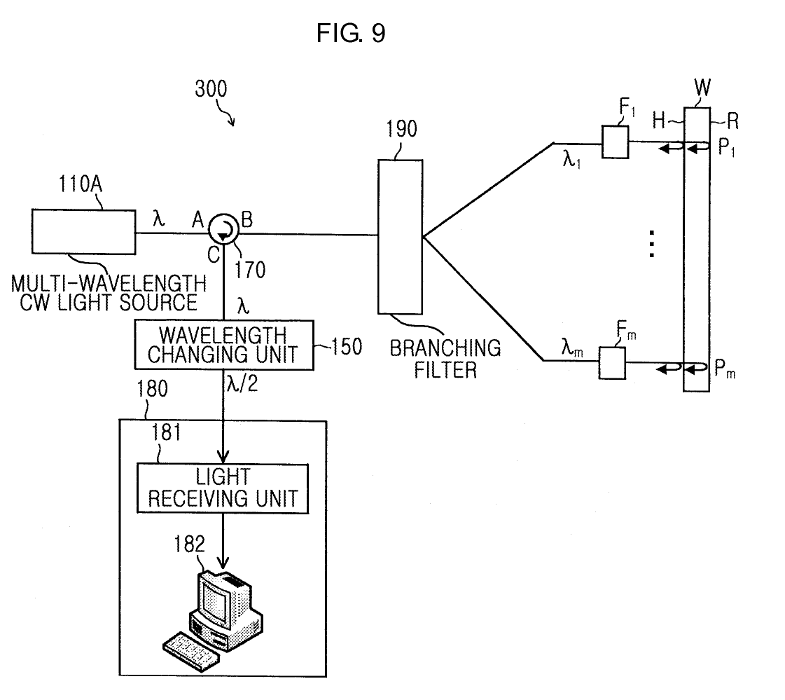

FIG. 9 is a diagram showing a configuration of a physical state measuring apparatus 300 according to a third embodiment. The physical state measuring apparatus 300 according to the third embodiment is different from the physical state measuring apparatus 200 in that a multi-wavelength CW light source 110A which generates a light having a wide wavelength band instead of the CW light source 110 is used, a multi-wavelength light (measurement light) generated by the multi-wavelength CW light source 110A is wavelength-divided into a plurality of measurement lights respectively having wavelengths λ₁ through λₘ by a branching filter 190, and the measurement lights obtained by the branching filter 190 are respectively emitted to different measurement points P₁ through Pₘ of the object to be measured W (for example, a semiconductor wafer).

Also, intervals between the wavelengths of the light generated by the multi-wavelength CW light source 110A, that is, the wavelengths λ₁ through λₘ, may be different from one another. This is because when second-harmonic waves are generated by the wavelength changing unit 150, difference frequency waves are simultaneously generated to prevent a signal-noise ratio (SNR) from decreasing.

Also, although reflected lights having the wavelengths λ₁ through λₘ from the measurement points P₁ through Pₘ are combined and then input to the light receiving unit 181, only a reflective light having a wavelength desired to be processed by the temperature calculating unit 182 may be extracted from the CCD image sensor 181b.

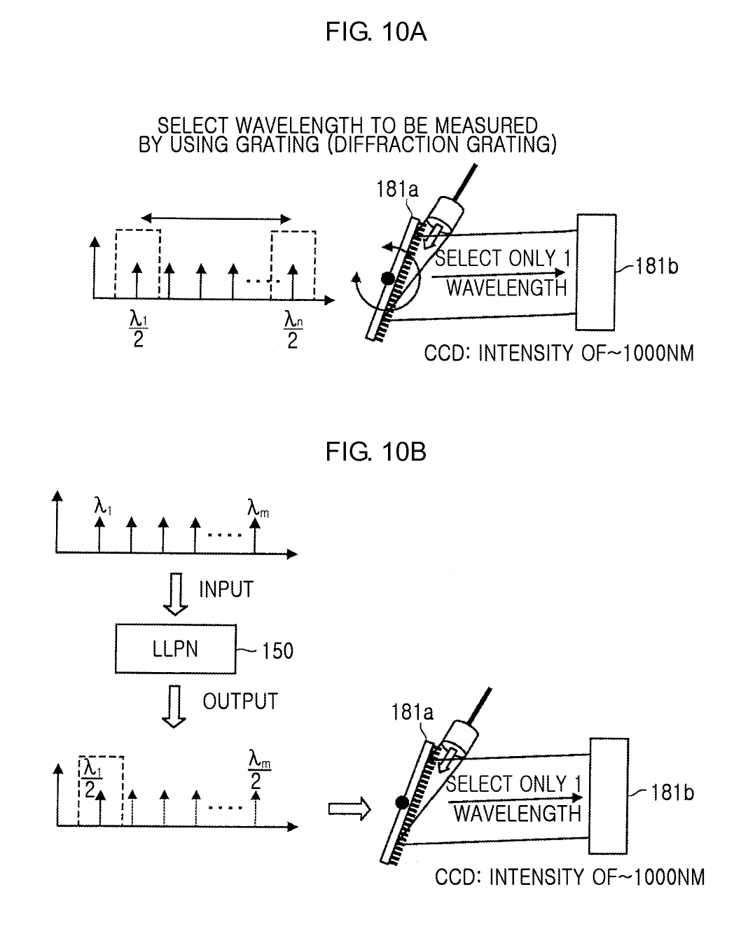

Besides, a specific wavelength may be selected from a multi-wavelength light (reflected light) input from the wavelength changing unit 150 and may be received by the CCD image sensor 181b by rotating the diffraction grating 181a as shown in FIG. 10A. In this case, since a wavelength λ incident on the light receiving unit 181 is changed to a wavelength (λ/2) by the wavelength changing unit 150, a rotation angle of the diffraction grating 181a is reduced to half, and thus a time taken to select a specific wavelength by rotating the diffraction grating 181 can be reduced.

Also, a PPLN (periodically poled lithium niobate) crystal which can select a wavelength of a second-harmonic wave may be used as the wavelength changing unit 150 as shown in FIG. 10B. Other configurations are the same as those of the physical state measuring apparatus 200 according to the second embodiment, and thus a repeated explanation thereof will not be given.

As described above, since the physical state measuring apparatus 300 according to the third embodiment uses the multi-wavelength CW light source 110A, a multi-wavelength light (measurement light) generated by the multi-wavelength CW light source 110A is wavelength-divided into a plurality of measurement lights respectively having wavelengths λ₁ through λₘ by the branching filter 190, and the measurement lights obtained by the branching filter 190 are respectively emitted to the different measurement points P₁ through Pₘ, temperatures of the plurality of measurement points can be simply measured.

Also, although physical states of the different measurement points P₁ through Pₘ of a specific object to be measured W are measured in the third embodiment, physical states of different objects to be measured W may be measured by using measurement lights respectively having wavelengths λ₁ through λₘ obtained by the branching filter 190.

### Fourth Embodiment

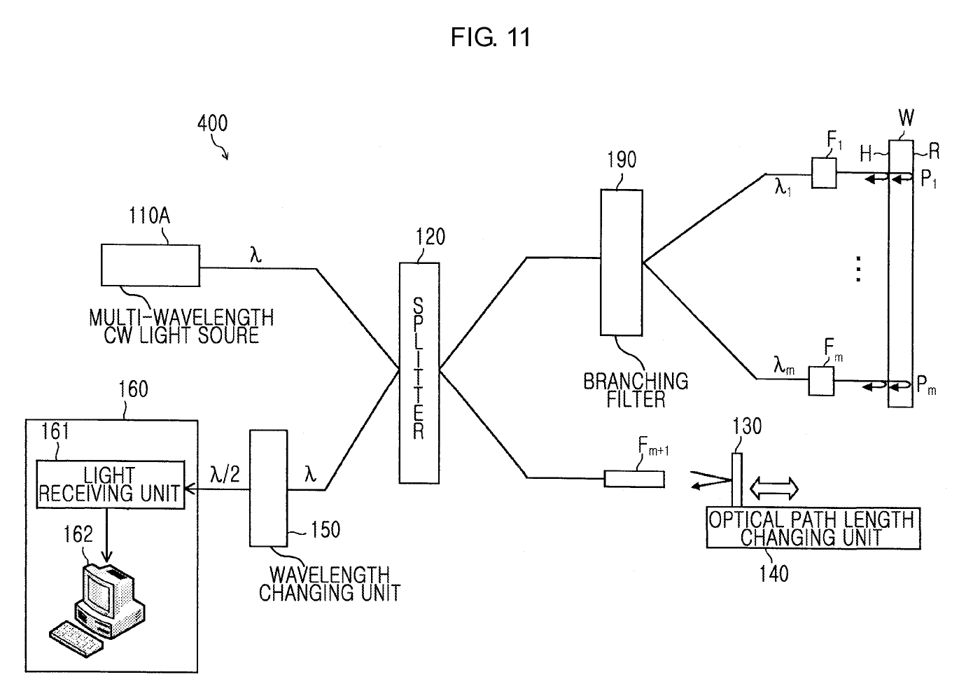

FIG. 11 is a diagram showing a configuration of a physical state measuring apparatus 400 according to a fourth embodiment. The physical state measuring apparatus 400 according to the fourth embodiment is different from the physical state measuring apparatus 100 according to the first embodiment in that the multi-wavelength CW light source 110A which generates a light having a wide wavelength band instead of the CW light source 110 is used, a multi-wavelength light (measurement light) generated by the multi-wavelength CW light source 110A is wavelength-divided into a plurality of measurement lights respectively having wavelengths λ₁ through λₘ by the branching filter 190, and the measurement lights obtained by the branching filter 190 are respectively emitted to different measurement points P₁ through Pₘ. Other configurations are the same as those of the physical state measuring apparatus 100 according to the first embodiment, and thus a repeated explanation thereof will not be given.

Since the physical state measuring apparatus 400 according to the fourth embodiment uses the multi-wavelength CW light source 110A, a multi-wavelength light generated by the multi-wavelength CW light source 110A is wavelength-divided into plurality of measurement lights respectively having wavelengths λ₁ through λₘ by the branching filter 190, and the measurement lights obtained by the branching filter 190 are respectively emitted to different measurement points P₁ through Pₘ, temperatures of the plurality of measurement points can be simply measured. Other effects are the same as those of the physical state measuring apparatus 100 according to the first embodiment.

Also, in order to extract a specific wavelength from the plurality of wavelengths λ₁ through λₘ, the light receiving unit 161 may be used or a diffraction grating may be provided in front of the light receiving unit 161, as described in the third embodiment. Also, a PPLN crystal which can select a wavelength of a second-harmonic wave may be used as the wavelength changing unit 150.

### Other Embodiment

Also, the present invention is not limited to the embodiments, and various changes in form and details may be made therein without departing from the scope of the present invention. For example, a temperature of the object to be measured W is measured in the above embodiments. If layers or structures having different refractive indices exist in the object to be measured W, a measurement light causes interference by being reflected by the layers or the structures. Accordingly, it is possible to measure other physical states (for example, an internal structure) of the object to be measured W. Also, if a wavelength of a measurement light is changed, physical states of various other structures (for example, a human body) instead of a semiconductor wafer formed of Si may be measured.

According to the present invention, a physical state measuring apparatus and a physical state measuring method can measure a physical state of an object to be measured at a higher speed than that of a conventional apparatus and method.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A physical state measuring apparatus comprising:
a light source;
a transmitting unit which transmits a light from the light source to a measurement point of an object to be measured;
a nonlinear optical device which changes a wavelength of the light reflected by the measurement point to a wavelength that is different from the wavelength of the light before the changing;
a light receiving unit which receives the light whose wavelength has been changed; and
a measuring unit which measures a physical state of the object to be measured at the measurement point based on a waveform of the light received by the light receiving unit.

2. The physical state measuring apparatus of claim 1, wherein the light source generates a light having a plurality of wavelengths,
the transmitting unit transmits lights obtained by wavelength-dividing the light having the plurality of wavelengths to different measurement points of the object to be measured;
the nonlinear optical device changes each of the plurality of wavelengths of the lights reflected by the measurement points to a wavelength which is different from a wavelength before the changing, and
the physical state measuring apparatus further comprises a wavelength selecting unit which selects a light having a specific wavelength from the lights whose wavelengths have been changed and inputs the light having the specific wavelength to the light receiving unit.

3. The physical state measuring apparatus of claim 2, wherein intervals between the plurality of wavelengths are different from one another.

4. The physical state measuring apparatus of claim 2, wherein the wavelength selecting unit comprises a periodically poled lithium niobate (PPLN) crystal or an acousto-optic device.

5. The physical state measuring apparatus of claim 1, wherein the object to be measured is a semiconductor wafer, and
the physical state is a temperature of the semiconductor wafer.

6. The physical state measuring apparatus of claim 1, wherein the light source generates a light having a wavelength equal to or greater than 1000 nm, and
the light receiving unit comprises a charge-coupled device (CCD) image sensor or a complementary metal-oxide-semiconductor (CMOS) image sensor.

7. The physical state measuring apparatus of claim 1, further comprising:
a dividing unit which divides the light from the light source into a measurement light and a reference light;
a reference light reflecting unit which reflects the reference light from the dividing unit; and
an optical path length changing unit which changes an optical path of the reference light reflected by the reference light reflecting unit.

8. A physical state measuring method comprising:
transmitting a light from a light source to a measurement point of an object to be measured;
changing a wavelength of the light reflected by the measurement point to a wavelength that is different from the wavelength of the light before the changing;
receiving the light whose wavelength has been changed; and
measuring a physical state of the object to be measured at the measurement point based on a waveform of the received light.

9. The physical state measuring method of claim 8, wherein the light source generates a light having a plurality of wavelengths,
In the transmitting, lights obtained by wavelength-dividing the light having the plurality of wavelengths are transmitted to different measurement points of the object to be measured;
In the changing, each of the plurality of wavelengths of the lights reflected by the measurement points is changed to a wavelength which is different from a wavelength before the changing, and
the physical state measuring method further comprises selecting a light having a specific wavelength from the lights whose wavelengths have been changed and outputting the light having the specific wavelength.

10. The physical state measuring method of claim 9, wherein intervals between the plurality of wavelengths are different from one another.

11. The physical state measuring method of claim 8, wherein the object to be measured is a semiconductor wafer, and
the physical state is a temperature of the semiconductor wafer.

12. The physical state measuring method of claim 8, further comprising:
dividing the light from the light source to a measurement light and a reference light;
reflecting the reference light; and
changing an optical path length of the reflected reference light.
